(19) United States
(12) Patent Application Publication
(10) Pub. No.: US 2012/0130980 A1
(43) Pub. Date: May 24, 2012

(54) SYSTEM AND METHOD FOR SEARCHING NETWORK-ACCESSIBLE SITES FOR LEAKED SOURCE CODE

(75) Inventors: Onn Chee Wong, Singapore (SG); Siew Keng Loh, Singapore (SG); Hui Yang, Beijing (CN); You Liang Wang, Beijing (CN)

(73) Assignee: RESOLVO SYSTEMS PTE LTD, Singajpore (SG)

(21) Appl. No.: 13/055,903

(22) PCT Filed: Jul. 25, 2008
(86) PCT No.: PCT/SG2008/000272

§ 371 Date: Jun. 28, 2011

(51) Int. Cl. G06F 17/30

(52) U.S. Cl. 707/709; 707/E17.108

(57) ABSTRACT

A method of detecting leakage of sensitive source code on network-accessible sites is provided. The method includes determining a set of unique identifying elements that identify a sensitive source code module accessed from a source code repository; using a crawler server connected to an external network to automatically search a list of one or more network-accessible sites for text that matches one or more of the unique identifying elements in the set of unique identifying elements, to provide search results; collecting the search results in a memory of the crawler server; determining a relevancy for each of the search results based at least in part on a number of the unique identifying elements that were matched and on a number of search results; sorting the results according to the relevancy; and providing the results to a user, to indicate whether sensitive source code was found on the network-accessible sites.

### TECHNICAL FIELD

Embodiments relate generally to and a system and a method for searching network-accessible sites for leaked source code.

### BACKGROUND

Information Leakage Detection and Prevention (“ILDP”) is an emerging and fast-growing area in the field of information security. The business drivers to prevent information leakage have existed since the Information Age. Due to the limitation of technological options in the past, organisations have been relying on measures with limited effectiveness, such as legal penalties. However, such measures are corrective in nature but do not prevent leakages from occurring. With information going digital and the growing prevalence of Internet access, the risk of sensitive corporate information/intellectual assets being leaked out poses a problem.

One common shortcoming of existing ILDP solutions is that they aim to protect every single valuable information, which leads to lengthy and laborious attempts to try to understand how every employee uses potentially sensitive information. Some ILDP solutions, especially those with client-side agents, require complex and time-consuming installation and configuration. Other conventional solutions require users to copy sensitive information to centralised locations, resulting in interruption to business users.

In addition, organisations generally do not know the data context and hence are not able to create the relevant rules. The general approach of the other ILDP solutions makes this problem worse by requiring the organisations to understand the data context fully.

Most ILDP solutions do not possess context awareness and implement policies in a one-sided manner—by looking at the sender or source—without identifying who the recipients are. This further exacerbates the perception that ILDP obstructs, more than provide benefits to, business.

In addition, there is no existing ILDP solution that is able to detect information that is already leaked out to the Internet sites. With the increased popularity of Web 2.0 applications, the speed of spreading of information has increased, which makes timely discovery of public domain leakages more important.

Another shortcoming of the existing ILDP solutions is that there is no segregation of access to collected information from an administrator. This means all sensitive information that is captured by the ILDP system will be made available to the administrators.

Therefore, there is a need to provide a new method and system which overcome at least one of the above-mentioned problems.

### SUMMARY

In an embodiment, there is provided a method of detecting leakage of sensitive source code on network-accessible sites, the method including: determining a set of unique identifying elements that identify a sensitive source code module accessed from a source code repository; using a crawler server connected to an external network to automatically search a list of one or more network-accessible sites for text that matches one or more of the unique identifying elements in the set of unique identifying elements, to provide search results; collecting the search results in a memory of the crawler server; determining a relevancy for each of the search results based at least in part on a number of the unique identifying elements that were matched and on a number of search results; sorting the results according to the relevancy; and providing the results to a user, to indicate whether sensitive source code was found on the network-accessible sites.

In another embodiment, there is provided a system for searching network-accessible sites for leaked source code, the system including: a source code repository storing one or more source code modules; a management device that interacts with a user; and a crawler server connected to an external network, the crawler server configured to: determine a set of unique identifying elements that identify a sensitive source code module accessed from the source code repository; search a list of one or more network-accessible sites for text that matches one or more of the unique identifying elements in the set of unique identifying elements, to provide search results; collect the search results in a memory of the crawler server; determine a relevancy for each of the search results based at least in part on a number of the unique identifying elements that were matched and on a number of search results; sort the results according to the relevancy; and send the results to the management device, to indicate to a user whether sensitive source code was found on the network-accessible sites.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the various embodiments. In the following description, various embodiments are described with reference to the following drawings, in which:

FIG. 1 shows a flowchart of a process for detecting leakage of sensitive source code on network-accessible sites in accordance with an embodiment.

FIG. 2 shows a schematic diagram of a system for searching network-accessible sites for leaked source code in accordance with an embodiment.

FIG. 3 shows an exemplary piece of source code.

FIG. 4 shows a table of elements extracted from a piece of source code being classified as unique identifying elements or generic elements.

FIG. 5 shows a flowchart of process steps for determining the set of unique identifying elements that identify the sensitive source code module accessed from the source code repository.

FIG. 6 shows a schematic diagram of a system implemented in a digital communication network.

FIG. 7 shows a schematic diagram of a computer system for implementing the processes for detecting leakage of sensitive source code on network-accessible sites and the system for searching network-accessible sites for leaked source code.

### DETAILED DESCRIPTION

Exemplary embodiments of a method of detecting leakage of sensitive source code on network-accessible sites and a system for searching network-accessible sites for leaked source code are described below. It will be appreciated that the exemplary embodiments described below can be modified in various aspects without changing the essence of the invention.

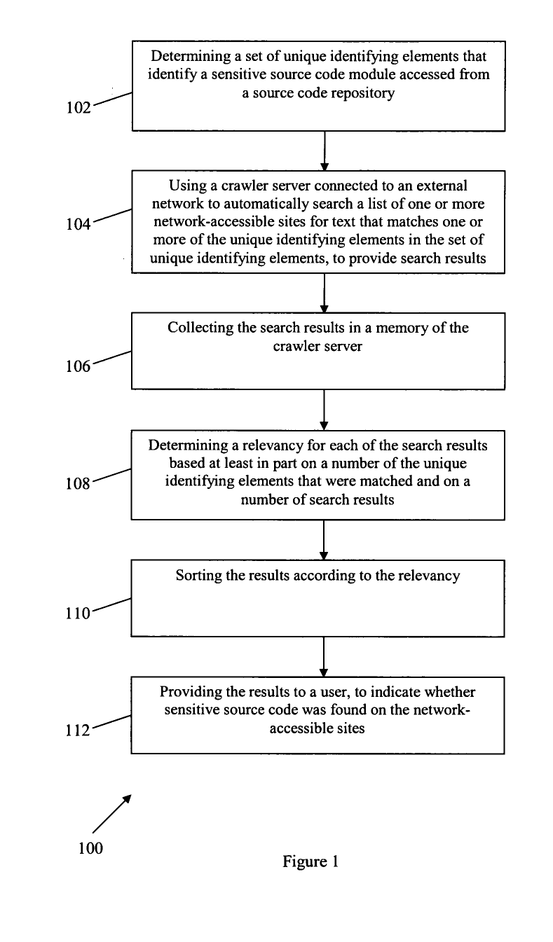

FIG. 1 shows a flowchart 100 of a process for detecting leakage of sensitive source code on network-accessible sites. In 102, a set of unique identifying elements that identify a sensitive source code module accessed from a source code repository may be determined. In 104, a crawler server connected to an external network to automatically search a list of one or more network-accessible sites for text that matches one or more of the unique identifying elements in the set of unique identifying elements, may be used to provide search results. In 106, the search results may be collected in a memory of the crawler server. In 108, a relevancy for each of the search results may be determined, based at least in part on a number of the unique identifying elements that were matched and on a number of search results. In 110, the results may be sorted according to the relevancy. In 112, the results may be provided to a user, to indicate whether sensitive source code was found on the network-accessible sites.

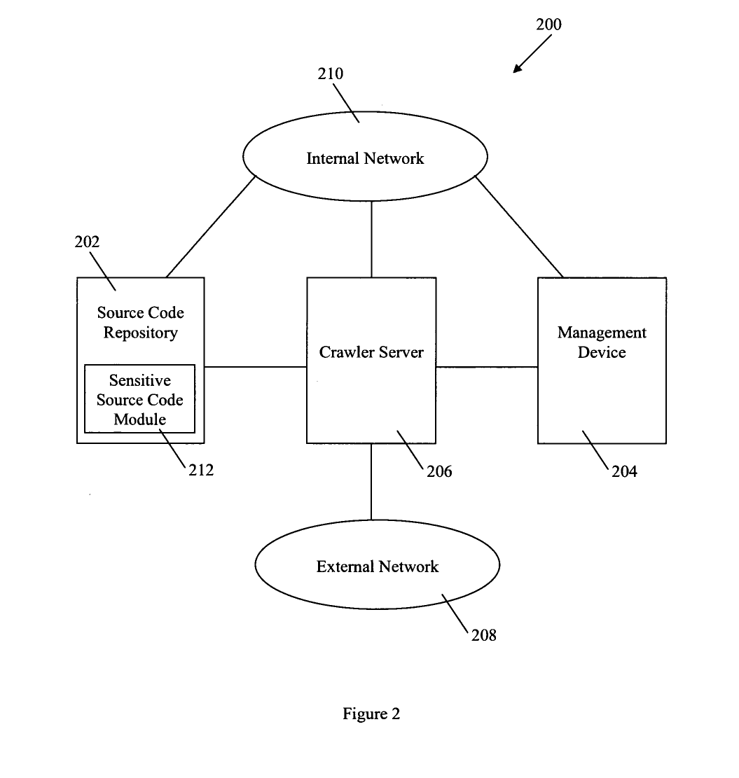

FIG. 2 shows a schematic diagram of a system 200 for searching network-accessible sites for leaked source code. The system 200 may include a source code repository 202 that may store one or more source code modules; a management device 204 that may interact with a user; and a crawler server 206. The crawler server 206 may be connected to an external network 208. The external network 208 may be a network that is not controlled by the organization that controls the crawler server 206, source code repository 202, and/or management device 204. The external network 208 may include but may not be limited to the Internet. The source code repository 202, the management device 204 and the crawler server 206 may be connected to an internal network 210. The source code repository 202 may be located in the internal network 210. The internal network 210 may be a network controlled by an organization.

The crawler server 206 may be configured to determine a set of unique identifying elements that identify a sensitive source code module 212 accessed from the source code repository 202. The crawler server 206 may search a list of one or more network-accessible sites for text that matches one or more of the unique identifying elements in the set of unique identifying elements, to provide search results. The crawler server 206 may also collect the search results in a memory (not shown) of the crawler server.

Further, the crawler server 206 may determine a relevancy for each of the search results based at least in part on a number of the unique identifying elements that were matched and on a number of search results. The crawler server 206 may sort the results according to the relevancy. The crawler server 206 may send the results to the management device 204, to indicate to a user whether sensitive source code was found on the network-accessible sites.

The crawler server 206 may provide active monitoring and detection of leakages to the external network 208. The crawler server 206 may operate by automatically logging into one or more of the network-accessible sites and performing search-and-filter activities. These network-accessible sites may not be accessible to popular search engines. These network-accessible sites may be designated by a user of the system 200.

The search-and-filter activities performed by the crawler server 206 may be broken down into a plurality of phases (e.g. two phases). An initial search phase may be performed to list out a summary of results ranked in order of relevance. Users can then review the summary results and instruct the crawler server 206 to perform a more in-depth search of the selected initial results. Wherever possible, multiple search functions offered by the designated Internet sites may be utilized by the crawler server 206 to provide more accurate and comprehensive searches. The above activities can be performed on demand by the administrators or as scheduled.

Inputs to the online search can be manually entered or automatically derived by the crawler server 206 after accessing protected information repositories and evaluating the protected content. For example, the crawler server 206 can automatically access a source code repository of an organisation, extract the source codes, obtain the unique identifying elements of the extracted source codes and perform searches using the unique identifying elements.

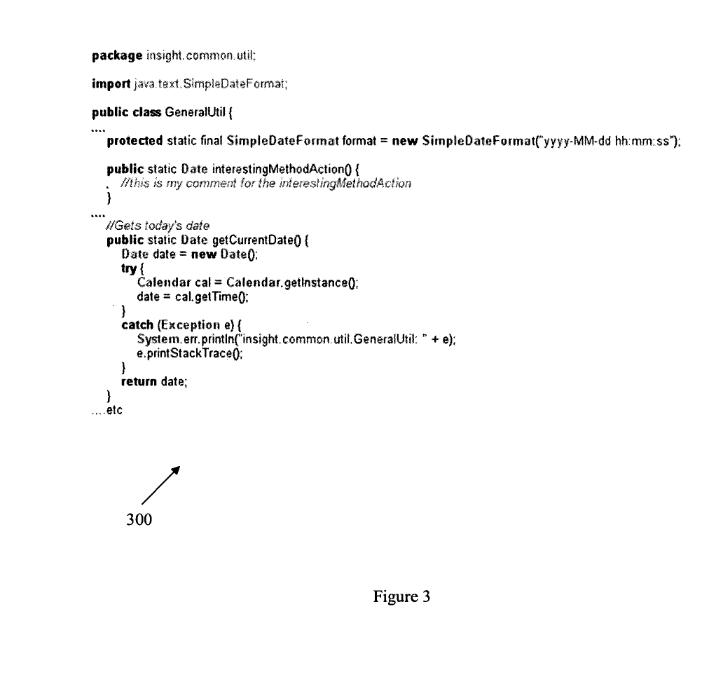

An exemplary piece of source code 300 named GeneralUtil.java is shown in FIG. 3. The exemplary source code 300 is used for illustrating the detailed process of obtaining unique identifying elements.

Initially, elements may be extracted from the source code 300. The elements extracted from the source code 300 may be categorized into a plurality of element types. The element types may include:
One-line comments;
Declared Package names (for programming languages which support this);
Method names;
Class names; and
File names.
Different element types may be used for categorizing the elements extracted from the source code in different embodiments. The number of element types may also be different in other embodiments.

Next, each of the elements extracted from the source code 300 may be checked, to determine whether it is an unique identifying element, using uniqueness rules. The uniqueness rules may include:
a) Length of the element; and
b) Whether the element is included in a blacklist of common/generic words.
   Different uniqueness rules may be used in different embodiments. The number of uniqueness rules may also be different in other embodiments.

Either one uniqueness rule or a combination of uniqueness rules may be applied to each element type. For example,
1. The uniqueness rule “Length of the element” may be applied to the element type “One-line Comments”.
2. The uniqueness rule “Length of the element” may be applied to the element type “Declared Package Names”, starting (in some embodiments) with a hierarchy of 2 levels, e.g. “com.mycompany”. An example element extracted from the source code 300 is “insight.common”.
3. The uniqueness rule “Length of the element” may be applied to the element type “Method Names”. The elements categorized under the element type “Method Names” may also be compared to the blacklist of common/generic words.
4. The uniqueness rule “Length of the element” may be applied to the element type “Classes Names”. The elements categorized under the element type “Classes Names” may also be compared to the blacklist of common/generic words.
5. The uniqueness rule “Length of the element” may be applied to the element type “File Name”. The elements categorized under the element type “File Name” may also be compared to the blacklist of common/generic words.

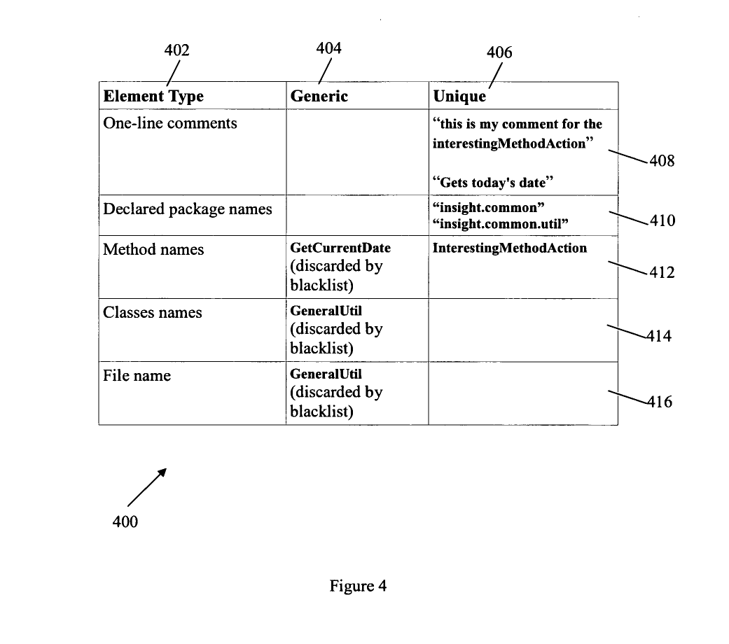

FIG. 4 shows a table 400 of elements extracted from the source code 300 classified as unique identifying elements or generic elements. Column 402 shows the various element types, column 404 shows the elements determined as generic, and column 406 shows the elements determined as unique identifying elements.

Row 408 shows elements, e.g. “this is my comment for the interestingMethodAction” and “Gets today's date”, categorized the element type “One-line Comments” determined as unique identifying elements. Row 410 shows elements, e.g. “insight.common” and “insight.common.util”, categorized the element type “Declared Package Names” determined as unique identifying elements. Row 412 shows an element, e.g. InterestingMethodAction, categorized the element type “Method Names” determined as an unique identifying element. These elements may have a length above a predetermined length threshold if the uniqueness rule “Length of the element” is applied.

By applying the uniqueness rule “Length of the element”, Elements such as “getID” and “setID”, having a length below a predetermined length threshold may not be determined as an unique identifying element. Elements having a length below a predetermined length threshold may be excluded to improve the accuracy of the search and to reduce false positives.

Row 412 also shows an element, e.g. GetCurrentDate, categorized the element type “Method Names” determined as a generic element. Row 414 shows an element, e.g. GeneralUtil, categorized the element type “Classes Names” determined as a generic element. Row 416 shows an element, e.g. GeneralUtil, categorized the element type “File Name” determined as a generic element. These elements may be found in the blacklist of common/generic words, and will therefore not be determined to be “unique” if the uniqueness rule applying the blacklist is applied.

When all the unique identifying elements are obtained, the crawler server 206 may proceed to perform searches with a plurality of combinations of the unique identifying elements. Searches may be performed in a descending order of relevance, starting with the highest relevance, i.e. matches to all unique identifying elements. The crawler server 206 may perform searches starting from the more relevant element type “One-line comments” to the less relevant element type “File names”. There can be e.g. thirty-one types of combination searches from the e.g. five elements types that the crawler server 206 analyzes.

The thirty-one types of combination searches are listed in the following:

### Types of Combinations:

1^{st}: All One-line Comments+All Packages+All Methods+All Classes+File name=Highest relevance
2^{nd}: 0 One-line Comments+All Packages+All Methods+All Classes+File name
3^{rd}: 0 One-line Comments+0 Packages+All Methods+All Classes+File name . . .
31^{st}: 0 One-line Comments+0 Packages+0 Methods+0 Classes +File name=Least relevance

After a specific combination search is completed, the next unique identifying element in the same element type may be used for the subsequent combination search. To reduce the number of results, the user may configure a limit to the maximum number of results returned from each combination search.

After the search results are obtained, they may be ranked in a descending order of relevancy. Relevancy may be computed using the following formula:

Relevancy value=CombinationPoints/TotalSearchResults

where

CombinationPoints=(One-Line Comment*Points per comment)+(Declared Package Name*Points per package)+(Method Name*Points per method)+(Class Name*Points per class)+(File Name*Points per filename)

and

TotalSearchResults=the number of results retrieved when searching using that combination.

CombinationPoints may be divided by TotalSearchResults to provide higher weightage to combinations that result fewer results, i.e. more unique. For example:
Case 1: Calculation for a combination search using one Class Name which returns 100 records

Relevancy value=[(0*25)+(0*18)+(0*13)+(1*10)+(0*2)]/100=0.1
Case 2: Calculation for a combination search using one File Name which returns 1 record

Relevancy value=[(0*25)+(0*18)+(0*13)+(0*10)+(1*2)]/1=2

In this example, the result of Case 2is ranked higher in terms of relevancy than the result of Case 1 although Case 1 uses a more relevant element type.

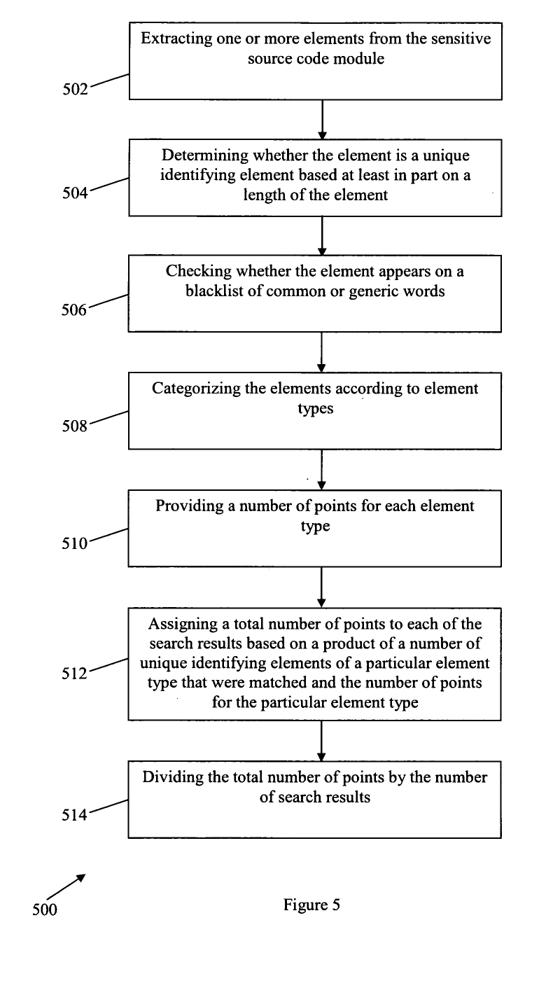

FIG. 5 shows a flowchart 500 of a process for determining the set of unique identifying elements that identify the sensitive source code module accessed from the source code repository. In 502, one or more elements may be extracted from the sensitive source code module. For each extracted element, the element may be checked to determine whether it is a unique identifying element based at least in part on a length of the element in 504. The element may not be a unique identifying element if it has a length below a predetermined length threshold. In 506, the element may be checked whether the element appears on a blacklist of common or generic words to determine if the element is a unique identifying element.

In 508, the elements may be categorized according to element types. The element types may include: one-line comments; declared package names; method names; class names; and file names. In 510, a number of points may be provided for each element type. In 512, a total number of points may be assigned to each of the search results based on a product of a number of unique identifying elements of a particular element type that were matched and the number of points for the particular element type to determine a relevancy for each of the search results. In 514, the total number of points may be divided by the number of search results to determine a relevancy for each of the search results.

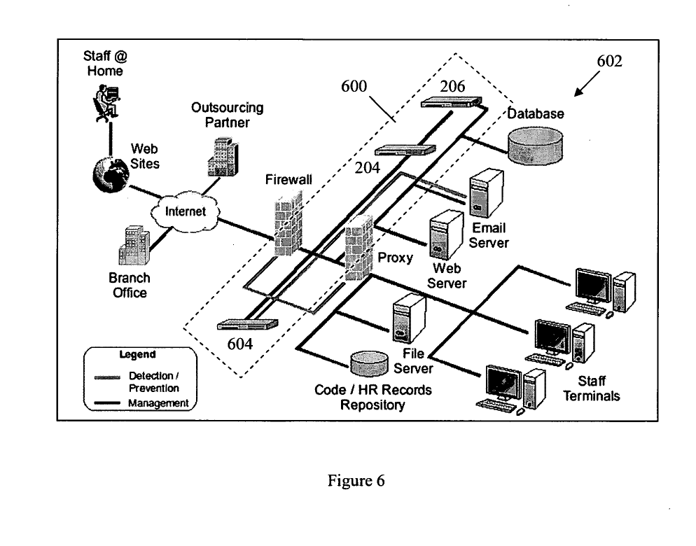

FIG. 6 shows a schematic diagram of a system 600 implemented in a digital communication network 602. The system 600 may have three components, namely a network gateway device 604, the management device 204 and a crawler server 206. In different embodiments, the system 600 may comprise different components and the number of components for the system 600 may also vary.

The network gateway device 604 may analyze the digital information transmitted over the network and may apply relevant policies to a digital communication. The network gateway device 604 may intercept the digital communication being sent from an internal network to an external network. The network gateway device 604 may include three parts, namely a correlation engine, a source code detection module and a network traffic analyzer. In different embodiments, the network gateway device 604 may have different parts and the number of parts of the network gateway device 604 may also vary.

The management device 204 may be a management and administration tool that can be used to control the network gateway device 604 and the crawler server 206, and to provide management reports. The system may comprise a plurality of the management devices 204 to provide scalability. The crawler server 206 of the system 600 may search e.g. Internet sites for leakages of information.

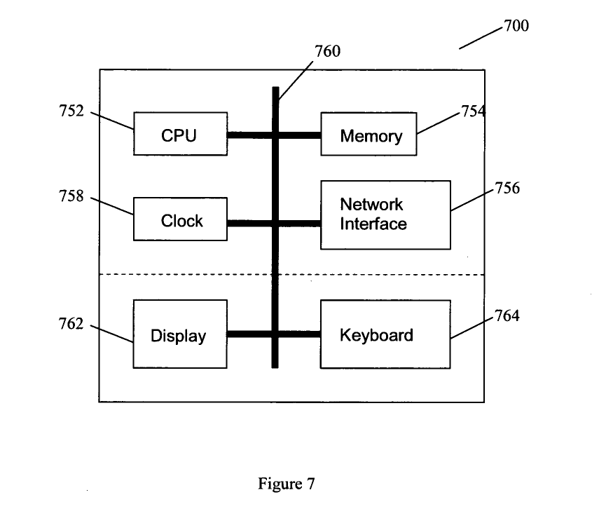

FIG. 7 shows a schematic diagram of a computer system 700 for implementing the processes for detecting leakage of sensitive source code on network-accessible sites and the system for searching network-accessible sites for leaked source code. The computer system 700 may provide the ability to detect leakage of sensitive source code on network-accessible sites and to search network-accessible sites for leaked source code.

The crawler server 206 may be implemented as the computer system 700. The computer system may include a CPU 752 (central processing unit), and a memory 754. The memory 754 may be used for collecting search results. The memory 754 may include more than one memory, such as Random Access Memory (RAM), Read-Only Memory (ROM), Erasable Programmable Read-Only Memory (EPROM), hard disk, etc. wherein some of the memories are used for storing data and programs and other memories are used as working memories. The computer system 700 may include an input/output (I/O) device such as a network interface 756. The network interface 756 may be used to access an external network such as the Internet, and an internal network such as Local Area Network (LAN) or Wide Area Network (WAN). The computer system 700 may also include a clock 758, an output device such as a display 762 and an input device such as a keyboard 764. All the components (752, 754, 756, 758, 762, 764) of the computer system 700 are connected and communicating with each other through a bus 760.

The memory 754 may be configured to store instructions for detecting leakage of sensitive source code on network-accessible sites. The instructions, when executed by the CPU 752, may cause the processor 752 to determine a set of unique identifying elements that identify a sensitive source code module accessed from the source code repository, to provide search results by searching a list of one or more network-accessible sites for text that matches one or more of the unique identifying elements in the set of unique identifying elements, to collect the search results in the memory 754, to determine a relevancy for each of the search results based at least in part on a number of the unique identifying elements that were matched and on a number of search results, to sort the results according to the relevancy, and to send the results to the management device to indicate to a user whether sensitive source code was found on the network-accessible sites.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of detecting leakage of sensitive source code on network-accessible sites, the method comprising:
determining a set of unique identifying elements that identify a sensitive source code module accessed from a source code repository;
using a crawler server connected to an external network to automatically search a list of one or more network-accessible sites for text that matches one or more of the unique identifying elements in the set of unique identifying elements, to provide search results;
collecting the search results in a memory of the crawler server;
determining a relevancy for each of the search results based at least in part on a number of the unique identifying elements that were matched and on a number of search results;
sorting the results according to the relevancy; and
providing the results to a user, to indicate whether sensitive source code was found on the network-accessible sites.

2. The method of claim 1, wherein using a crawler server connected to an external network to automatically search a list of one or more network-accessible sites comprises searching for a plurality of combinations of unique identifying elements selected from the set of unique identifying elements.

3. The method of claim 1, wherein determining a set of unique identifying elements comprises:
extracting one or more elements from the sensitive source code module; and
for each extracted element, determining whether the element is a unique identifying element based at least in part on a length of the element.

4. The method of claim 3, wherein determining whether the element is a unique identifying element based on a length of the element comprises determining that the element is not a unique identifying element if it has a length below a predetermined length threshold.

5. The method of claim 3, wherein determining whether the element is a unique identifying element further comprises checking whether the element appears on a blacklist of common or generic words.

6. The method of claim 3, wherein determining a set of unique identifying elements comprises categorizing the elements according to element types.

7. The method of claim 6, wherein the element types comprise two or more of:
one-line comments;
declared package names;
method names;
class names; and
file names.

8. The method of clam 6, further comprising providing a number of points for each element type, and wherein determining a relevancy for each of the search results comprises assigning a total number of points to each of the search results based on a product of a number of unique identifying elements of a particular element type that were matched and the number of points for the particular element type.

9. The method of claim 8, wherein the determining a relevancy for each of the search results further comprises dividing the total number of points by the number of search results.

10. The method of claim 6, wherein using a crawler server connected to an external network to automatically search a list of one or more network-accessible sites comprises searching for a plurality of combinations of unique identifying elements selected from the set of unique identifying elements in an order based at least in part on the element types.

11. The method of any of claim 1, wherein determining a set of unique identifying elements comprises accessing the source code repository over an internal network.

12. The method of claim 1, wherein providing the results to a user comprises sending the results to a management device over an internal network.

13. A system for searching network-accessible sites for leaked source code, the system comprising:
a source code repository storing one or more source code modules;
a management device that interacts with a user; and
a crawler server connected to an external network, the crawler server configured to:
determine a set of unique identifying elements that identify a sensitive source code module accessed from the source code repository;
search a list of one or more network-accessible sites for text that matches one or more of the unique identifying elements in the set of unique identifying elements, to provide search results;
collect the search results in a memory of the crawler server;
determine a relevancy for each of the search results based at least in part on a number of the unique identifying elements that were matched and on a number of search results;
sort the results according to the relevancy; and
send the results to the management device, to indicate to a user whether sensitive source code was found on the network-accessible sites.

14. The system of claim 13, wherein the external network comprises the Internet.

15. The system of claim 13, further comprising an internal network, wherein the source code repository, the management device, and the crawler server are connected to the internal network.

16. The system of claim 13, wherein the crawler server is configured to determine the set of unique identifying elements by:
extracting one or more elements from the sensitive source code module; and
for each extracted element, determining whether the element is a unique identifying element based at least in part on a length of the element.

17. The system of claim 16, wherein the crawler server is configured to determine that the element is not a unique identifying element if it has a length below a predetermined length threshold.

18. The system of claim 16, wherein the crawler server is configured to determine whether the element is a unique identifying element by checking whether the element appears on a blacklist of common or generic words that is stored on the crawler server.

19. The system of claim 16, wherein the crawler server is configured to categorize the one or more elements according to element types.

20. The system of claim 19, wherein the element types comprise two or more of:
one-line comments;
declared package names;
method names;
class names; and
file names.

21. The system of claim 19, wherein the crawler server is further configured to provide a number of points for each element type, and to determine a relevancy for each of the search results by assigning a total number of points to each of the search results based on a product of a number of unique identifying elements of a particular element type that were matched and the number of points for the particular element type.

22. The system of claim 21, wherein the crawler server is configured to determine a relevancy for each of the search results by dividing the total number of points by the number of search results.
